(19) United States
(12) Patent Application Publication
(10) Pub. No.: US 2015/0040518 A1
(43) Pub. Date: Feb. 12, 2015

(54) PROMOTIONAL METHOD UTILIZING VARIABLE GLASS MOLDS

(71) Applicant: Ardagh Group, Muncie, IN (US)

(72) Inventors: Robert M. Shanteau, St. Albans, MO (US); Steven W. Martin, Ridgeville, IN (US)

(21) Appl. No.: 14/454,340

(22) Filed: Aug. 7, 2014

Related U.S. Application Data
(60) Provisional application No. 61/863,120, filed on Aug. 7, 2013.

(51) Int. Cl. G09F 23/00; C03B 9/197; B65B 61/02; B65B 3/02; B65B 7/28

(52) U.S. Cl. CPC G09F 23/00; B65B 3/02; B65B 7/28; B65B 61/025; C03B 9/197; G09F 2023/0025
USPC 53/411; 65/79

(57) ABSTRACT

Methods and apparatus for individually molding objects as part of a marketing promotion. Various embodiments pertain to the use of individualized molds to simultaneously produce a plurality of molded consumer objects, each having molded individualized indicia. In other embodiments the molded individualized indicia further interrelates to additional individualized indicia that is printed in association with the molded object, such as on a label or a cap.

### CROSS REFERENCE TO RELATED APPLICATION

This application claims the benefit of priority to U.S. Provisional Patent Application Ser. No. 61/863,120, filed Aug. 7, 2013, Incorporated herein by reference.

### FIELD OF THE INVENTION

Various embodiments of the present invention pertain to promotional methods for the sale of consumer products, and in some embodiments to the use of glass containers molded with and displaying a variety of design features.

### SUMMARY OF THE INVENTION

One aspect of the present invention pertains to a method of promoting a product in a molded glass bottle. Some embodiments further include establishing a set of predetermined designs, each of the designs having a pre-existing historical relationship to each other design, this relationship preferably having been established prior to the product promotion. In yet other embodiments the set of designs may be established in conjunction with a product promotion, such as a set of designs each of which relates to characters in a new movie. Other embodiments include molding a plurality of glass bottles, each bottle being embossed with a design selected from the set of designs, such as the set associated with playing card (the 52 card logos), a set of dominos, a set of chess pieces, or the like. Yet other embodiments include placing the product in each of the plurality of bottles. Still other embodiments include distributing the bottles to a plurality of locations. In those embodiments in which the set of designs are further associated with particular locations, those bottles with the specific designs are preferentially distributed to the location associated with that design.

Another aspect of the present invention pertains to a method of manufacturing molded glass bottles. Some embodiments include providing a plurality of standard molds for molding of bottles of the same size and shape from glass. As examples, the molds may produce a wine bottle, or in other applications a narrow neck bottle, such as a bear bottle. Yet other embodiments include embossing into each of the plurality of standard molds a corresponding design that is different than any of the other designs (logos, emblems, designs, or patterns) embossed into any of the other standard molds. After this embossing, each of the standard molds have become specialized molds. Still other embodiments include operating a plurality of individual section (IS) machines, each IS machine including a plurality of the embossed molds.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

FIG. 1 is a schematic diagram of a machine for making glass containers for use with an illustrated embodiment.

FIG. 2 are CAD-generated, photographic representations of glass bottles according to one embodiment of the present invention.

FIG. 3 is a schematic representation of apparatus and methods according to one embodiment of the present invention for generating glass containers with a variety of design features and utilizing a variety of different labels.

FIG. 4 is a perspective, underside view of a bottle cap displaying data according to one embodiment of the present invention.

FIG. 5 is a front planar view of a label for a bottle displaying data according to one embodiment of the present invention.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments.

The use of an N-series prefix for an element number (NXX.XX) refers to an element that is the same as the non-prefixed element (XX.XX), except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same, since these common features are apparent to a person of ordinary skill in the related field of technology. Further, it is understood that the features 1020.1 and 20.1 may be backward compatible, such that a feature (NXX.XX) may include features compatible with other various embodiments (MXX.XX), as would be understood by those of ordinary skill in the art. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various references may be made to one or more processes, algorithms, operational methods, or logic, accompanied by a diagram showing such organized in a particular sequence. It is understood that the order of such a sequence is by example only, and is not intended to be limiting on any embodiment of the invention.

Various embodiments of the present invention pertain to methods and apparatus for producing a collection of individualized glass bottles. In some embodiments this collection is part of a promotional game intended to encourage sales of the product. The containers are produced such that there are a plurality of different container debossments that correspond to complementary embossments within the mold that was used to fabricate the glass container. Preferably, most other aspects of such a container are common with other simultaneously produced containers. Various design features such as wall thickness, bottle height, shape of the neck, etc., are common among the various containers.

These containers are made simultaneously on a plurality of Individual Section (IS) machines, preferable being fed from a single source of molten glass, and in some embodiments being arranged in a triple-gob configuration. The process for making these individualized bottles is preferably standardized through the fabrication and use of the same parison shape. However, each parison is provided to a unique mold. In some embodiments, as many as thirty different molds are simultaneously producing bottles that have any of a variety of different debossments. Although what is being shown and described pertains in some embodiments to the molding of glass containers, it is understood that yet other embodiments pertain to the molding of bottles from any material, including plastic.

In still further embodiments, the finished bottles (or more generally, containers) are provided to a seller that fills the container with a product that is sold to consumers. Typically, the seller applies one or more labels and a cap or lid to each of the containers. In yet other embodiments one or more of these labels are chosen from a plurality of different labels. The labels may differ with regards to shape, color, printing, or other variables, including printing or images that appear when the label is reduced in temperature. In such embodiments, when the consumer purchases the end product, that product is presented in a container that includes one of a plurality of container debossments associated with one of a different plurality of container labels. The consumer can use his knowledge of the molded, debossed features along with information taken from the label or cap to an internet website operated by the seller, used in a video game, or used on a smart phone such as for downloading of an app or use of an existing app.

It is further understood that the various container debossments and the various container labels and caps can change over time. For example, a first plurality of debossments may represent National Football League teams, such as for containers sold in the fourth quarter of a year. The various molds can be changed out to include debossments of National Basketball Association teams for containers sold in the first quarter of the year. Yet another set of predetermined designs pertain to the names or identifying logos of the countries participating in the FIFA World Cup. Further, containers fabricated at one manufacturing facility may include molds engraved with logos pertaining to Civil War organizations or Revolutionary War military organizations or the like (for example, state regiments).

The various labels can include a plurality of different indicia also. For example, some labels may pertain to famous dates in history, or refer to the names of U.S. presidents. Still further, this date or name information may be given in terms of printed clues. In some embodiments, the information may not be visible unless the container is brought to a chilled state within a refrigerator. It is further contemplated in some embodiments that the various container molds and labels are changed over time, and not repeated. Therefore, some combinations of container mold and label information are issued during certain time periods, and then not issued again.

One objective of such container-making and label-printing methods is to encourage the consumers to engage in an internet game. As the consumers acquire the product, they can enter the molded information and the label information onto an internet site. Some combinations of debossment/printed indicia will lead the consumer to different areas within the website. As time passes and molds and labels are changed and the consumer purchases additional product, the input of the new container data onto the website provides still further internet content (such as prizes or awards, unique internet content that is generally not otherwise available, or the like). Preferably, this internet game is adapted and configured so as to be played over a long period of time, and further such that continued purchasing of the product provides additional data that the consumer can use to access otherwise restricted areas, and more types of entertainment, awards, or the like.

In yet other embodiments, bottles prepared by any of the methods presented herein are usable in a video game. In such embodiments, the manufacturer of the container or the seller of the container with the finished product have an agreement with a provider of a video game, that data from the molded container (such as data pertaining to the molded design itself, data from the label, or data printed on the cap) can be entered by a user in the video game to enhance the user's playing abilities within the game. As one example, the entry of data or a code on the label could permit the user to obtain additional lives or playing time. As another example, the entry of the combination of the first code from a label and the second code from the cap could permit the user to acquire a “cheat code” useful in the game. As yet another example, the continued entry of a variety of data and codes could permit activities by the user in the video game that are not otherwise obtainable with only a single code or smaller number of codes.

In still further embodiments, the entry of information about the molded design, data from a first code, or data from a second code can be entered by a consumer on a smart phone. The data may be entered into a particular app, especially those apps in which the owner or operator of the app has a pre-established marketing agreement with either the maker of the container or the provider of the final product to the consumer, such that the app provides additional programmed features to the consumer. In still further embodiments, the information presented on the bottle (one or more of the design or any of the printed codes) is used to download a new smart phone app or other computer program.

In some embodiments, the container purchased by the consumer includes a code on the label or cap that is printed and distributed to consumers on a limited basis. Consumers would therefore be provided with containers that have a molded design selected from a predetermined set of molds, with a large number of containers being produced and sold that include any particular design. However, the code printed on the label or the cap may be provided to the consumers on an extremely limited basis, such as on one label out of a set of one million labels. In such embodiments the number of containers including both the selected design and the special code would be greatly limited, but would provide the consumer with substantial promotional benefits. In such embodiments, the promotional method can include the requirement that the consumer, prior to obtaining the substantial benefits, must physically present the intact container to a representative of the container manufacturer or product seller.

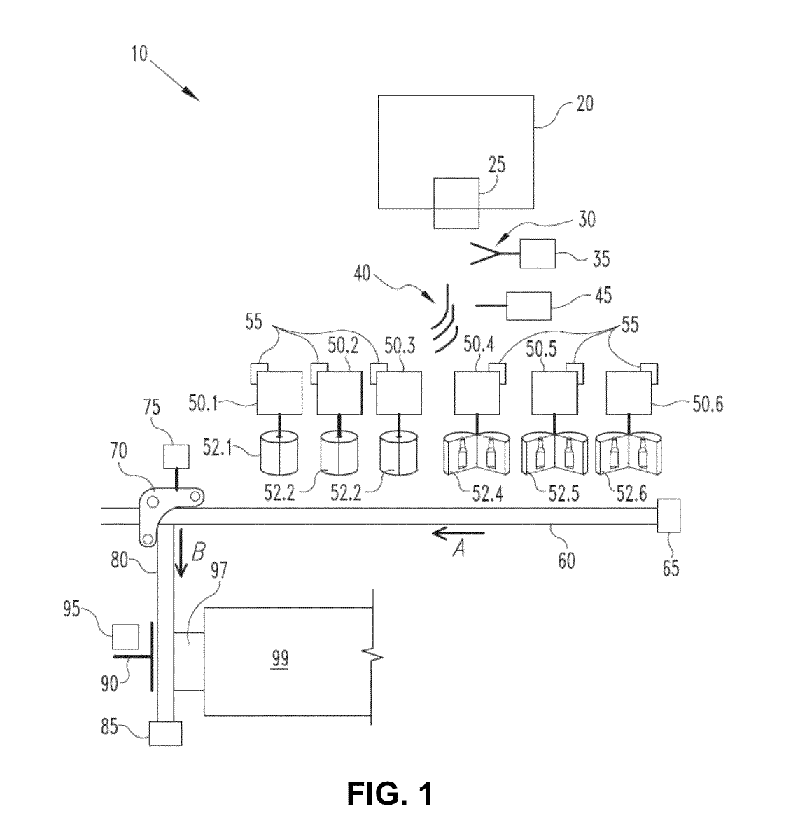

The embodiment shown in FIG. 1 controls an “individual section” (“IS”) machine that implements any of the variety of techniques known for converting a gob of molten glass into a formed article. The machine includes a control system (also known as a “drive system”) for controlling the position, speed, and acceleration of various components of the glass making system is integrated with an event timing system and synchronizes the position, speed, direction, acceleration, and operational state of various AC and servo motors to position and move the mechanisms correctly. As with any continuous process, each machine has only a certain time window in which to complete each step of its process before the next cycle begins.

FIG. 1 illustrates a portion of a container-making process that is controlled by one embodiment of the present control system. In the system, feeder bowl 20 is fed by a continuous supply of molten glass. Feeder mechanism drive 25 allows one or more streams of molten glass to escape through the bottom of feeder bowl 20. Shears 30 are driven by shear drive 35 to cut each stream into gobs, sometimes two, three, or more at a time, which fall to gob distributor 40. Gob distributor drive 45 rotates gob distributor 40 so that each set of gobs is directed to an IS machine 50. The IS machine 50 forms each gob into a hollow container. Each IS 50 includes a mold 52 that receives a parison. Under a process referred to as narrow neck press and blow, the parison is charged internally with pressurized gas to form the parison into the shape of a container. Under the control of IS controllers 55, IS machines 50 form containers and place them onto main conveyor 60, which carries them in the direction of arrow A under the control of main conveyor drive 65.

Beyond the end of the row of IS machines 50, containers on main conveyor 60 encounter ware transfer wheel 70, which is controlled by transfer wheel drive 75. Ware transfer wheel 70 moves containers from main conveyor 60 onto cross conveyor 80, which is controlled by cross conveyor drive 85. Cross conveyor 80 moves the containers in the direction of arrow B toward the stacker 90, which is controlled by stacker drive 95. Stacker 90 ensures that the containers are properly spaced and moves them one row at a time onto lehr conveyor 97. Lehr conveyor 97 takes the formed containers into lehr 99, where the containers are annealed to strengthen the glass, as is known in the art.

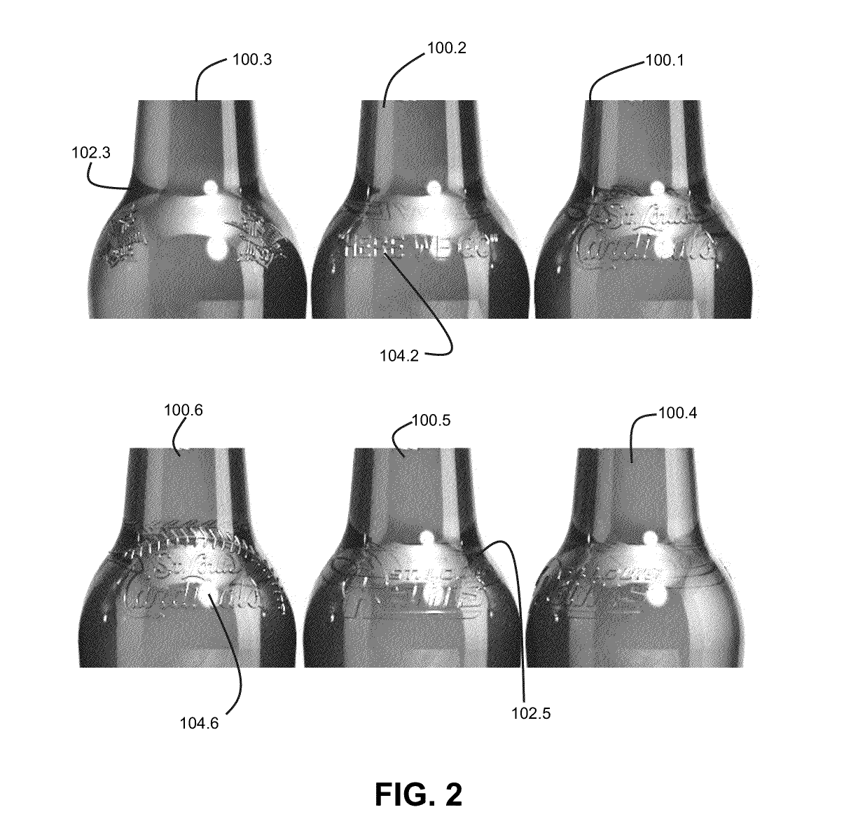

FIG. 1 further shows that each IS machine includes a mold 52 that receives in it an unfinished quantity of molten glass, such as a parison. As is known in the art, each mold 52 is typically a two part mold, the parts of which are joined together for formation of the container 100. The mold halves open for release of the container onto conveyor 60. FIG. 1 indicates that each IS machine (50.1-50.6) provides molten glass to a corresponding mold (52.1-52.6). Each mold 52.x is unique from each other mold, typically by way of engravings in the mold surface that produce different debossments on the final container. FIG. 2 shows a plurality of containers 100 (100.1-100.6), each produced from a different mold, and each showing a different debossment (100.1-100.6) located proximate to the shoulder (102.1-102.6) of the corresponding bottle.

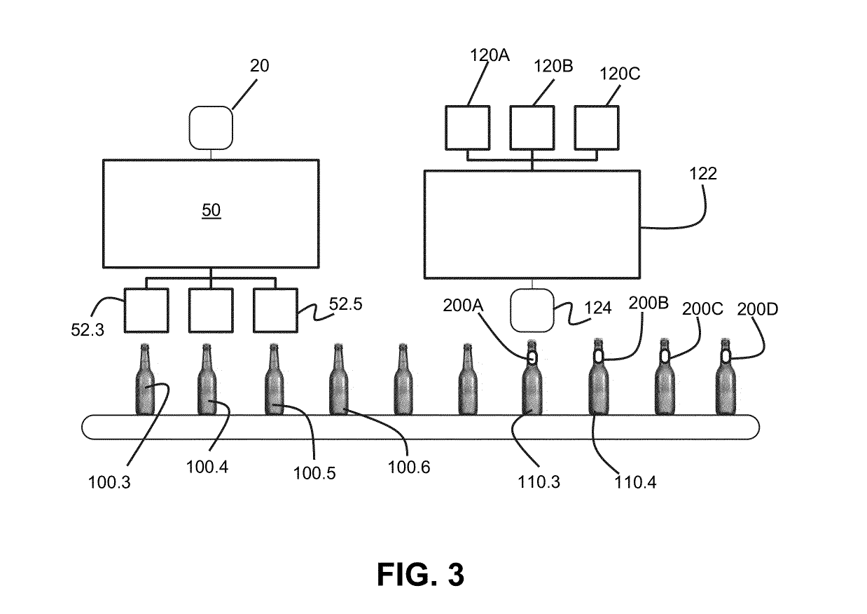

FIG. 3 schematically represents the preparation of a promotional product according to one embodiment of the present invention. As previously described, an IS machine 50 provides molten glass to a plurality of variably-internally embossed container molds 52. Each mold 52 produces a glass container different than the containers simultaneously being produced by other molds of that IS machine. These molded bottles are provided to a conveyor as shown in FIG. 1. For the sake of simplicity, FIG. 3 shows these bottles being provided on a “conveyor” to a labeling machine 122. It is understood that the practice in some industries is to finish and prepare glass containers at one facility, and then ship them to a seller's facility for labeling and introduction of the product. FIG. 3 shows this multi facility process on a single drawing for the sake of simplicity.

FIG. 3 shows the finished but unlabeled bottles 100 being provided to a conveyor for labeling by a labeling machine 122. A plurality of differently printed labels 120A, 120B, and 120C are provided to a machine 122 that includes an end effector 124 that applies the labels 200A, 200B, or 200C to the bottles 100 so as to create the encoded bottle 110. These bottles 110 are filled at the appropriate time with product, packaged, and sent to a distributor or sales facility for end sale to a consumer.

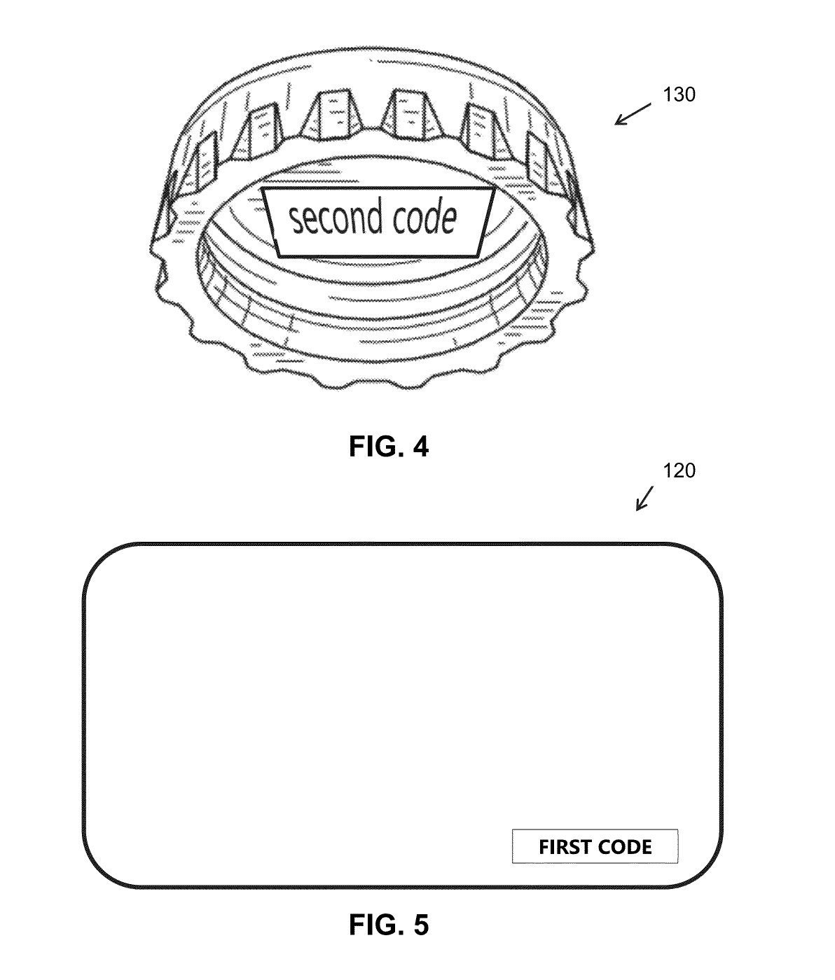

FIGS. 4 and 5 show a cap 130 and a label 120 prior to their placement on a container. Cap 130 preferably includes data such as a second code that is printed on the inside of the bottle cap. This code can be of any type, including alphanumeric information, a 2D matrix code (such as an Aztec code), barcode, or other characters, preferably including characters that can be scanned optically by a computer including a smart phone.

FIG. 5 shows one embodiment of a label 120 prior to its placement on a container. Label 120 includes data, such as a first code, that can be imprinted anywhere on the label such that it is readable by the consumer, and more preferably that it is readable optically by a computer including a smart phone. In some embodiments, the code is contained in a single contiguous area, such as a bar code, matrix code, or alphanumeric. In yet other embodiments, the coded information can be placed anywhere on the label, including codes that are dispersed among a plurality of words or symbols (for example, the second letter of the name of the product, the first letter of the name of the seller, and the like). In still further embodiments, either the first code or the second code may be useful in determining where and how additional coded information is presented on the particular label. In some embodiments, the coding of the cap and label takes advantage of the computer control and high dispensed volumes of the caps and labels, such that a large variety of indicia can be printed and distributed to consumers. Some embodiments envision the printing of certain indicia on a small number of caps and labels, these indicia being substantially more exclusive that other indicia, and providing increased benefits to the consumer that uses the indicia in the promotional scheme.

Various aspects of different embodiments of the present invention are expressed in paragraphs X1 and X2 as follows:

X1. One aspect of the present invention pertains to a method of promoting a product in a molded container. The method preferably includes establishing a set of predetermined designs, each of the designs having a pre-existing historical relationship to each other design. The method preferably includes molding a plurality of containers, each container being embossed with a design selected from the set of designs. The method preferably includes placing the product in each of the plurality of containers. The method preferably includes distributing the containers to a plurality of locations, each location being associated with at least one design from the set.

X2. Another aspect of the present invention pertains to a method of manufacturing molded containers. The method preferably includes providing a plurality of standard molds for molding of containers. The method preferably includes embossing into each of the plurality of standard molds a corresponding design that is different than any of the other designs embossed into any of the other standard molds. The method preferably includes operating a plurality of molding machines, each machine including a plurality of the embossed molds. The method preferably includes manufacturing in a substantially continuous manner a plurality of molded containers from each of the embossed molds.

Yet other embodiments pertain to any of the previous statements X1 or X2, which are combined with one or more of the following other aspects. It is also understood that any of the aforementioned X paragraphs include listings of individual features that can be combined with individual features of other X paragraphs.

Wherein the set of predetermined designs includes symbols from one of a deck of playing cards, chess pieces, or the tiles of a domino set.

Wherein the set includes at least one logo corresponding to a computer. Which further comprises placing a label on each of the plurality of containers, and each label includes a first code useful for downloading an application for a smartphone.

Which further comprises placing a cap on each of the plurality of containers, each cap including a second code useful in using the application.

Which further comprises placing a label on each of the plurality of containers, and each label includes a first code useful in playing a video game.

Which further comprises placing a cap on each of the plurality of containers, each cap including a second code useful in playing the video game.

Which further comprises placing a cap on each of the plurality of containers, each cap including a second code that modifies the effect of the first code in playing the video game

Wherein said placing a label is a label chosen from a predetermined set of labels, the set including a plurality of different first codes.

Which further comprises placing a label on each of the plurality of containers, each label including a written reference to the set of predetermined designs.

Which further comprises placing a label on each of the plurality of containers, and each label includes a code useful for downloading an application for a smartphone.

Which further comprises placing a label on each of the plurality of containers, and each label includes a code useful in playing a video game.

Wherein the set includes logos each corresponding to a team within a sporting organization.

Wherein the organization is one of the National Football League, Major League Soccer, Major League Baseball, or the National Basketball Association.

Wherein each logo refers to two teams within the sporting organization and a date on which the two teams played each other.

Wherein the set includes logos each corresponding to geographic locations.

Wherein the locations are one of states of the United States or countries of Europe.

Which further comprises placing a label on each of the plurality of containers, and each label includes a the name of a city within the location.

Wherein said operating includes continuously preparing a plurality of substantially similar parisons, and which further comprises placing each of the parisons into one of the embossed molds.

Wherein the machine is a triple-gob IS machine.

Wherein said embossing is on at least a portion of the neck or shoulder of the container.

Wherein said embossing is not on the lip, collar, body, or base of the container.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of promoting a product in a molded glass bottle, comprising:
establishing a set of predetermined designs, each of the designs having a pre-existing relationship to each other design;
molding a plurality of glass bottles, each bottle being embossed with a design selected from the set of designs;
placing the product in each of the plurality of bottles; and
distributing the bottles to a plurality of locations.

2. The method of claim 1 wherein the set of predetermined designs includes symbols from one of a deck of playing cards, chess pieces, or the tiles of a domino set.

3. The method of claim 1 wherein the set includes at least one logo corresponding to a computer.

4. The method of claim 3 which further comprises placing a label on each of the plurality of bottles, and each label includes a first code useful for downloading an application for a smartphone.

5. The method of claim 4 which further comprises placing a cap on each of the plurality of bottles, each cap including a second code useful in using the application.

6. The method of claim 3 which further comprises placing a label on each of the plurality of bottles, and each label includes a first code useful in playing a video game.

7. The method of claim 6 which further comprises placing a cap on each of the plurality of bottles, each cap including a second code useful in playing the video game.

8. The method of claim 6 which further comprises placing a cap on each of the plurality of bottles, each cap including a second code that modifies the effect of the first code in playing the video game.

9. The method of claim 6 wherein said placing a label is a label chosen from a predetermined set of labels, the set including a plurality of different first codes.

10. The method of claim 1 which further comprises placing a label on each of the plurality of bottles, each label including a written reference to the set of predetermined designs.

11. The method of claim 1 which further comprises placing a label on each of the plurality of bottles, and each label includes a code useful for downloading an application for a smartphone.

12. The method of claim 1 which further comprises placing a label on each of the plurality of bottles, and each label includes a code useful in playing a video game.

13. The method of claim 1 wherein the set includes logos each corresponding to a team within a sporting organization.

14. The method of claim 13 wherein the organization is one of the National Football League, Major League Soccer, Major League Baseball, or the National Basketball Association.

15. The method of claim 13 wherein each logo refers to two teams within the sporting organization and a date on which the two teams played each other.

16. The method of claim 1 wherein the set includes logos each corresponding to geographic locations.

17. The method of claim 16 wherein the locations are one of states of the United States or countries of Europe.

18. The method of claim 16 which further comprises placing a label on each of the plurality of bottles, and each label includes a the name of a city within the location.

19. A method of manufacturing molded glass bottles, comprising:
providing a plurality of standard molds for molding of bottles from glass;
embossing into each of the plurality of standard molds a corresponding design that is different than any of the other designs embossed into any of the other standard molds;
operating a plurality of individual section (IS) machines, each IS machine including a plurality of the embossed molds; and
manufacturing in a substantially continuous manner a plurality of molded glass bottles from each of the embossed molds.

20. The method of claim 19 wherein said operating includes continuously preparing a plurality of substantially similar parisons, and which further comprises placing each of the parisons into one of the embossed molds.

21. The method of claim 19 wherein the IS machine is a triple-gob IS machine.

22. The method of claim 19 wherein said embossing is on at least a portion of the neck or shoulder of the bottle.

23. The method of claim 19 wherein said embossing is not on the lip, collar, body, or base of the bottle.
